(19) United States
(12) Patent Application Publication
(10) Pub. No.: US 2007/0035536 A1
(43) Pub. Date: Feb. 15, 2007

(54) Display calibration method for optimum angular performance

(75) Inventors: Paula J. Alessi, Rochester, NY (US); John E. Ludwicki, Churchville, NY (US); Serguei Endrikhovski, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/202,015

(22) Filed: Aug. 11, 2005

(51) Int. Cl. G09G 5/00

(52) U.S. Cl. 345/207

(57) ABSTRACT

A method of calibrating a flat panel display, comprising the steps of: providing a flat panel display, calibrating the display to establish desired chromaticity and/or luminance for one or more colors of interest at a first reference angle, measuring the chromaticity and/or luminance data for at least one color of interest at a minimum of one additional reference angle distinct from the first reference angle, and selecting a target calibration angle in response to the measured data and calibrating the display to establish desired chromaticity and/or luminance for colors of interest at the selected target calibration angle. The target calibration angle may be selected to deliver optimal display performance as a function of one or more desired viewing angles. These viewing angles can be in the tip direction, turn direction or in a direction that is some combination of tip and turn.

### FIELD OF INVENTION

This invention relates to calibration of flat panel displays, and more particularly to calibration of color flat panel organic electroluminescent (EL) displays.

### BACKGROUND OF THE INVENTION

Full color organic electroluminescent (EL) displays, also known as organic light-emitting diode (or OLED) displays, have recently been demonstrated as a new type of flat panel display. In simplest form, an organic EL device is comprised of an electrode serving as the anode for hole injection, an electrode serving as the cathode for electron injection, and an organic EL medium sandwiched between these electrodes to support charge recombination that yields emission of light. An example of an organic EL device is described in U.S. Pat. No. 4,356,429. In order to construct a pixelated display device such as is useful, for example, as a television, computer monitor, cell phone display or digital camera display, individual organic EL elements can be arranged as an array of pixels in a matrix pattern. To produce a multicolor display, the pixels are further arranged into subpixels, with each subpixel emitting a different color. This matrix of pixels can be electrically driven using either a simple passive matrix or an active matrix-driving scheme. In a passive matrix, the organic EL layers are sandwiched between two sets of orthogonal electrodes arranged in rows and columns. An example of a passive matrix driven organic EL diode display is disclosed in U.S. Pat. No. 5,276,380. In an active matrix configuration, each pixel is driven by multiple circuit elements such as transistors, capacitors, and signal lines. Examples of such active matrix organic EL diode displays are provided in U.S. Pat. Nos. 5,550,066, 6,281,634, and 6,456,013.

OLED displays can be made to have one or more colors. Full color OLED displays are also known in the art. Typical full color OLED displays are constructed of pixels having three subpixels that are red, green, and blue in color. Such an arrangement is known as an RGB design. An example of an RGB design is disclosed in U.S. Pat. No. 6,281,634. Full color organic electroluminescent (EL) diodes have also recently been described that are constructed of pixels having four subpixels that are red, green, blue, and white in color. Such an arrangement is known as an RGBW design. An example of an RGBW device is disclosed in U.S. Patent Application Publication 2002/0186214 A1.

Several approaches to obtaining color displays are known in the art. For example, each differently colored subpixel can be constructed using one or more different OLED materials. These materials are selectively placed on the subpixels with methods including shadow masks, thermal transfer from a donor sheet, or ink jet printing. Another approach to producing a color display is to place OLED materials in a common stack of one or more layers across all the differently colored subpixels and then use one or more different color filters to selectively convert the common OLED color to different colors for each subpixel. In this case the OLED materials are typically arranged so as to produce a broad emission spectrum, also referred to as white emission or white OLED. An example of a white OLED with color filters is disclosed in U.S. Pat. No. 6,392,340.

Yet another approach to achieving a color display is to place the OLED emission element within a microcavity structure to enhance emission at a specific wavelength as determined by the optical cavity length of the microcavity. Examples of such microcavity devices are shown in U.S. Pat. Nos. 5,405,710 and 5,554,911. In this case, broad emitting OLED materials can be used and, by varying the optical length of the cavity for each differently colored subpixel, different colored emission can be achieved.

All of the aforementioned OLED device structures exhibit some level of chromaticity and/or luminance shift when viewed at different angles. This effect is described in U.S. Pat. No. 5,780,174. This is commonly referred to as “viewing angle dependence” of the display. Some OLED device structures exhibit this phenomenon more than others, but all typically have less viewing angle dependence than other display devices such as Liquid Crystal Displays (LCDs). A display device having reduced viewing angle dependence is desired so that the viewer is presented with a high-quality color image across a wide range of angles of view.

This problem has typically been addressed by changing the display structure to reduce the viewing angle dependency. Patents that describe display structure changes to improve viewing angle dependence include U.S. Pat. No. 5,406,396, U.S. Pat. No. 5,237,437, and U.S. Pat. No. 5,757,524, as well as commonly assigned, copending U.S. Ser. No. 10/762,675. Unfortunately, these methods do not totally eliminate the viewing angle dependence of the display and/or they are costly to implement. Therefore, a simpler method is desired for reducing the perceived viewing angle dependence of the display.

Flat panel OLED displays also have a fixed white point and a chromatic neutral response that result from their manufacturing process, such that variations in the typical manufacturing processes may result in unwanted variations in display color reproduction. Techniques for calibrating and driving such displays, as described, e.g., in US 2003/0025688 and U.S. Pat. No. 6,677,958, have been proposed to accommodate for such undesired variations. Calibration techniques have not been taught for reducing viewing angle dependence of displays.

### SUMMARY OF THE INVENTION

It is an object of the present invention to provide displays which, when viewed at various angles, have reduced variation in perceived color and luminance. In accordance with one embodiment, the invention is directed towards a method of calibrating a flat panel display, comprising the steps of:
a) providing a flat panel display,
b) calibrating the display to establish desired chromaticity and/or luminance for one or more colors of interest at a first reference angle,measuring the chromaticity and/or luminance data for at least one color of interest at a minimum of one additional reference angle distinct from the first reference angle, and
d) selecting a target calibration angle in response to the measured data and calibrating the display to establish desired chromaticity and/or luminance for colors of interest at the selected target calibration angle.
   The target calibration angle may be selected to deliver optimal display performance as a function of one or more desired viewing angles. These viewing angles can be in the tip direction, turn direction or in a direction that is some combination of tip and turn.

### ADVANTAGES

The invention has the advantage over conventional methods in that it improves overall viewing angle performance of the device without the need for, or in addition to, what can be achieved through device structure modifications. The invention is also much simpler to implement than a device structure modification.

### BRIEF DESCRIPTION OF THE DRAWINGS

FIG. 1 is flowchart showing the basic calibration process for optimum viewing angle performance;

FIG. 2 is a schematic diagram of a system useful in performing the calibration of a display for optimum viewing angle;

FIG. 3 is an illustration of the tip and turn directions for a display;

FIG. 4 is a flowchart showing an example of a flat panel display calibration process;

FIG. 5 is an example CIE 1976 u′,v′ diagram showing the u′,v′chromaticity as a function of reference turn angle for white as the color of interest;

FIG. 6 is a magnified portion of the same CIE 1976 u′,v′ diagram shown in FIG. 5;

FIG. 7 is an example plot of the CIE 1931 luminance values as a function of reference turn angle for white (the color of interest) as a function of reference turn angle;

FIG. 8 is an example b*, a* plot of the white color of interest as reference turn angle varies in the positive and negative directions;

FIG. 9 is an example L*, C*_{ab} plot of the white color of interest as reference turn angle varies in the positive and negative directions;

FIG. 10 is an example plot of the CIE 1976 CIELAB color difference parameters (delta E*_{ab}, delta L*, and delta C*_{ab}) for the white color of interest between each reference turn angle and the first target calibration angle of zero degrees;

FIG. 11 is a flow chart showing the target calibration angle selection process by maintaining color difference for the at least one color of interest below a threshold value within a selected range of viewing angles;

FIG. 12 is an example plot of the predicted CIELAB color difference data that would be obtained if 30 degrees were chosen as the new target calibration angle;

FIG. 13 is an example plot of the actual CIELAB color difference data that were obtained when 30 degrees was chosen as the new target calibration angle;

FIG. 14 is a flow chart showing the target calibration angle selection process by maintaining an acceptability metric for the at least one color of interest below a threshold value within a selected range of viewing angles;

FIG. 15 is an example plot of the acceptability of various delta E*ab values based on a representative psychophysical study;

FIG. 16 is a flow chart showing the target calibration angle selection process by reducing the power consumption and/or increasing the lifetime of a display white establishing desired chromaticity and/or luminance for the color(s) of interest.

### DETAILED DESCRIPTION OF THE INVENTION

In the following description, various aspects of the invention are described to provide a thorough understanding of the invention; however, the present invention is not limited to the specific embodiments and examples described herein. In addition, known aspects and specific details of color display devices, systems and methods may have been omitted or simplified for clarity.

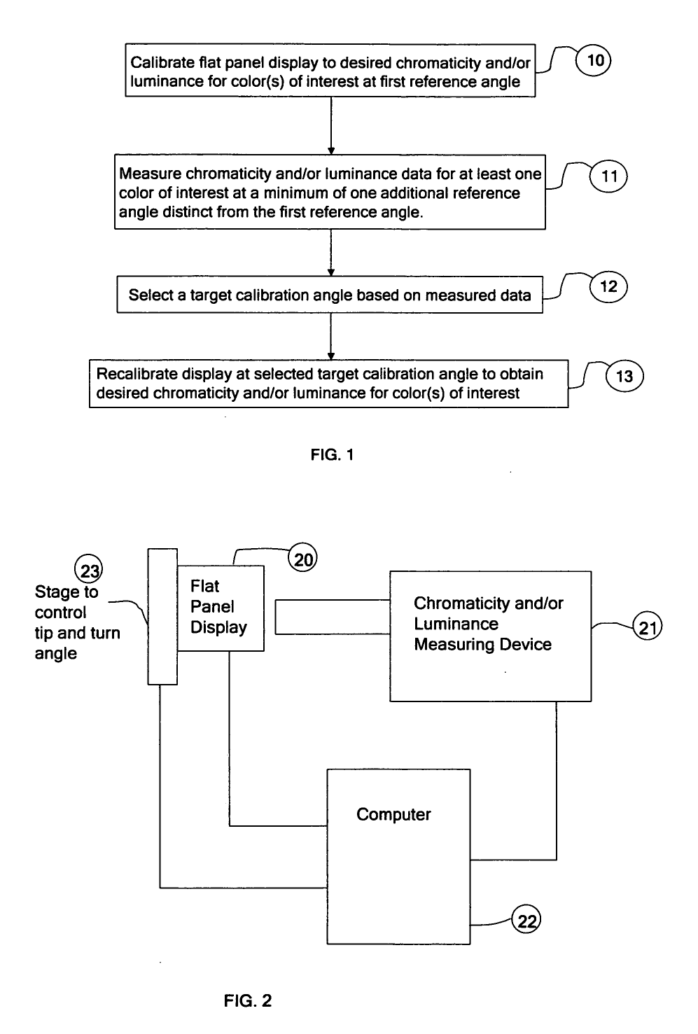

Referring to FIG. 1, calibrating a flat panel display for optimum viewing angle performance according to the present invention includes four components. First, the flat panel display is calibrated 10 to establish desired chromaticity and/or luminance for color(s) of interest at a first reference angle. Second, chromaticity and/or luminance data are measured 11 for at least one color of interest at a minimum of one additional reference angle distinct from the first reference angle. Third, a target calibration angle is selected 12 in response to the measured data. Finally, the display is calibrated 13 to establish desired chromaticity and/or luminance for the color(s) of interest at the selected target calibration angle.

Referring to FIG. 2, a system useful in performing the calibration of a flat panel display 20 for optimum viewing angle according to an embodiment of the present invention is shown. The components of the system include a computer 22, a flat panel display 20 mounted on a stage 23, and a chromaticity and/or luminance-measuring device 21.

According to the embodiment of FIG. 2 of the present invention, the flat panel display 20 may be provided with electronic amplifiers to adjust each individual color channel gain and offset, and master adjustment controls for gain and offset. The master controls allow simultaneous adjustment of the gain and offset for all color channels.

The computer 22 produces video signals with the appropriate timing parameters to produce targets on the flat panel display 20. The targets are a series of patches with code values representing the chromaticity and/or luminance of the colors of interest. The targets can be generated in the computer 22 by commercially available software packages such as Adobe PhotoShop™. Alternatively, a custom software program can be written to produce the targets.

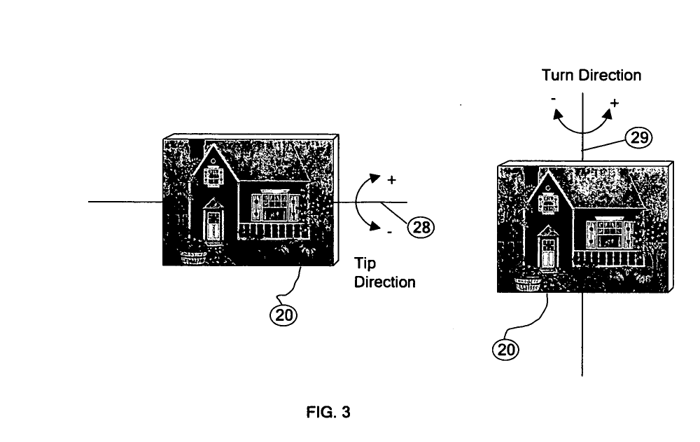

The chromaticity and/or luminance-measuring device 21 may be, e.g., either a colorimeter, such as the Minolta Colorimeter, or a spectroradiometer, such as a PhotoResearch PR-705. Either measuring device 21 should have sufficient sensitivity and accuracy to measure the display chromaticity and/or luminance. The chosen measuring device 21 could have the provision to read the measured light output via the computer 22 or manually using a built-in display on the measuring device 21. The stage 23 allows the flat panel display 20 to be accurately oriented to various tip and/or turn directions. The tip 28 and turn 29 directions are illustrated in FIG. 3. The tip direction 28 moves the flat panel display 20 about its horizontal axis. The turn direction 29 moves the flat panel display 20 about its vertical axis.

Referring to FIG. 1, the first step 10 in the calibration process according to the present invention is to calibrate the flat panel display to the desired chromaticity and/or luminance for color(s) of interest at a first reference angle. As indicated, this calibration step can use only chromaticity data or only luminance data, but, more commonly, both chromaticity and luminance data are used together. Also, the color(s) of interest could be a single color or a group of colors. The color(s) of interest could also include the display white point. In addition, the first reference angle could be at zero degrees relative to normal, or at a tip angle 28, turn angle 29, or a combination tip/turn angle 28/29 relative to normal.

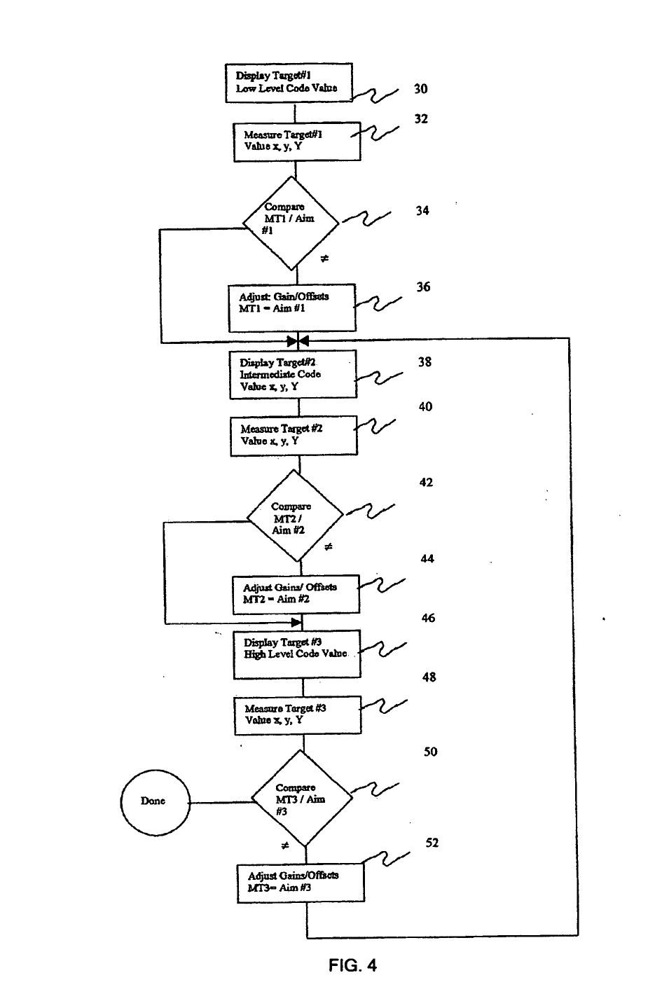

An exemplary process for completing the first step in the calibration process 10 is shown in FIG. 4. This process is most commonly performed with the white point of the display chosen as the color of interest, but other colors could be used. In addition, this process can be used for any chosen first reference angle, whether the first reference angle is at zero degrees relative to normal, or at a tip angle 28, turn angle 29, or a combination tip/turn angle 28/29 relative to normal. Referring to FIG. 4, the calibration is accomplished as follows. A first target using a low level code value for each channel is displayed 30. The luminance level of the displayed first target is sensed 32 using the measuring device 21 and the measured RGB values are compared 34 to a first aim value representing a luminance level at least 3 decades lower than a maximum luminance level. The gain and offset of the display are then adjusted 36 so that the sensed luminance level matches the predetermined aim value.

A second target is displayed 38 using intermediate code values for each channel of the display device. The luminance level and chromaticities of the displayed second target are sensed 40 and compared 42 with a second aim value representing an intermediate luminance level. The individual channel gains and offsets are then adjusted 44 so that the luminance level matches the second predetermined aim value and the chromaticities match a first set of predetermined chromaticities that represent the chosen color of interest.

A third target is displayed 46 using maximum code values for each channel of the display device. The luminance level and chromaticities of the displayed third target are sensed 48 and compared 50 with a third aim value representing the maximum luminance level. The individual channel gains and offsets are then adjusted 52 so that the luminance level matches a third predetermined aim value and the chromaticities match the first set of predetermined chromaticities. The above steps are repeated until all three aims are achieved to within a specified tolerance. An example of this process is described in more detail in U.S. Patent Application Publication No. 20030025688A1, the disclosure of which is incorporated by reference herein. Additional steps are also included in the above referenced patent application publication, which may or not have to be performed according to the present invention. If there is more than one color of interest, the process described in FIG. 4 is repeated for each color of interest. The present invention, however, does not preclude the use of other calibration methods.

Referring to FIG. 1, the second step 11 in the calibration process according to the present invention is to measure chromaticity and/or luminance data for at least one color of interest at a minimum of one additional reference angle distinct from the first reference angle. The at least one color of interest could be a single color or group of colors that may include the display white point. The at least one color of interest could be different than the one or more colors of interest in the first step 10 of this calibration process, according to the present invention. These chromaticity and/or luminance measurements should be done using the same measuring device 21 as was used in the first step of the calibration process 10. Also, the additional reference angles distinct from the first reference angle, could be a plurality of angles in the tip direction, turn direction, or in a combination tip/turn direction relative to the first reference angle. The additional measured reference angles could consist of a range of tip angles 28, turn angles 29, and combination tip/turn angles 28/29 that lie within a range of anticipated viewing angles for use in a particular application. For instance, the typical tip viewing angle range for a Digital Still Camera (DSC) display is approximately −10 to +50 degrees, and the turn angle range is approximately +/−45 degrees. For a Personal Digital Assistant (PDA) display, the typical tip viewing angle range is approximately −25 to +45 degrees, and the turn angle range is approximately +/−30 degrees. +/−30 degrees. Alternately, the additional measured viewing angles could consist of a sampling of the full range of physically possible tip angles, turn angles and combination tip and turn angles. Theoretically, the full range of physically possible viewing angles lie between +/−90 degrees tip and +/−90 degrees turn relative to normal, but a more practical range of physically possible viewing angles lie between +/−75 degrees tip and +/−75 degrees turn. In fact, most measuring instruments cannot measure chromaticity and/or luminance at angles beyond +/−75 degrees in either the tip or turn direction.

For example, a display was initially calibrated according to the process of FIG. 4 choosing the display white point as the color of interest and 0 degrees tip/turn relative to normal as the first reference angle in the first step 10 of the calibration process. The display white point in this case was set to an aim chromaticity corresponding to the CIE Standard Illuminant D65 (CIE 1976 u′,v′ =0.1978, 0.4683) with a luminance of 120 cd/m². The chromaticity and luminance data were then measured for the same color of interest at several additional reference turn angles 29 distinct from the first reference angle as indicated by the second step 11 in the calibration process. The additional reference angles were chosen to be from −85 to +85 in the turn direction 29 only. These data in terms of CIE 1976 u′,v′ chromaticity values, CIE 1931 x,y chromaticity values, and CIE 1931 luminance values are shown in Table 1. The data for the first reference angle of 0 degrees tip/turn is also shown in Table 1. Notice that the measured data for the first reference angle at zero degrees comes close to matching the CIE Standard Illuminant D65 aim. The CIE 1976 u′,v′ chromaticity values were calculated using the CIE 1931 x,y measured data.

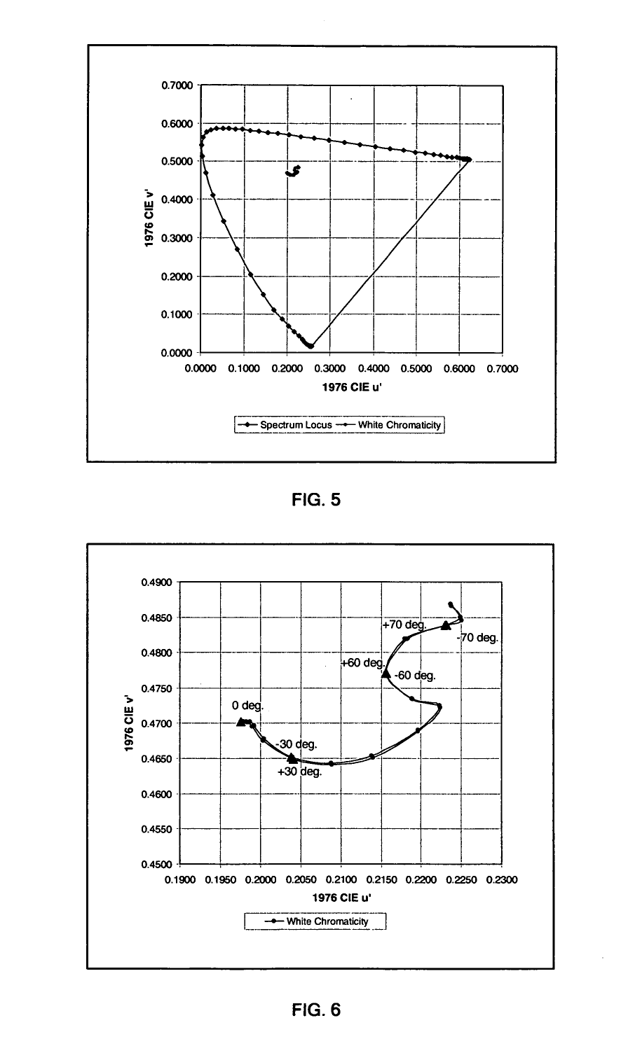

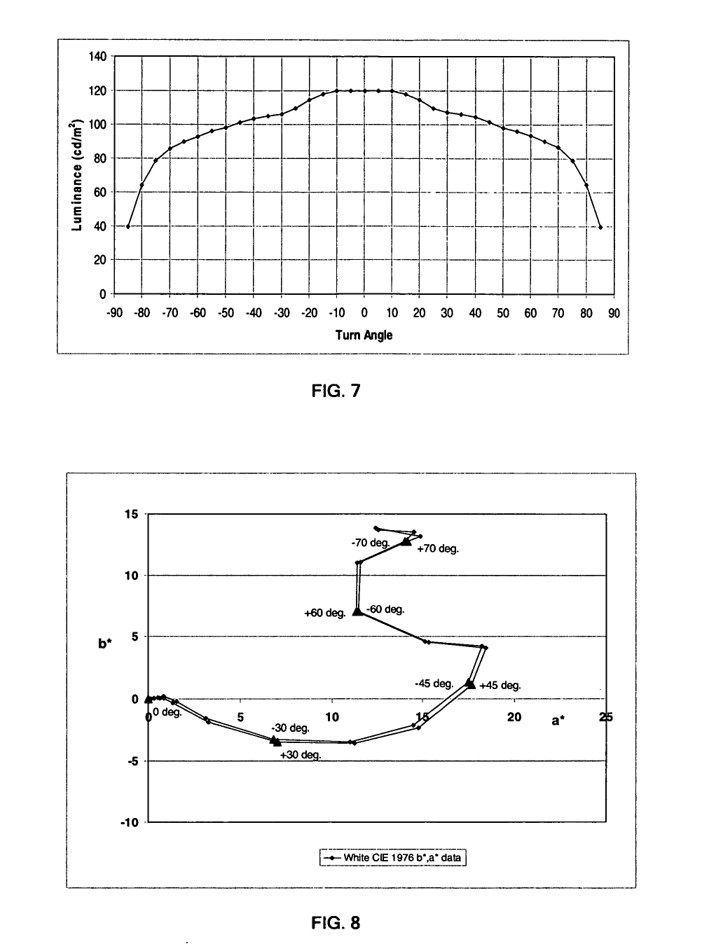

FIG. 5 shows the chromaticity as a function of reference turn angle on the CIE 1976 u′,v′ diagram. The spectrum locus is also shown on this diagram. FIG. 6 shows a magnified portion of the CIE 1976 u′,v′ diagram to better illustrate the magnitude of the chromaticity shifts. Notice that the chromaticity shifts are approximately symmetrical in the positive and negative turn directions relative to the first reference turn angle of zero degrees. This symmetry may not be found for all flat panel displays, but the methods described herein can still be applied. FIG. 7 shows the CIE 1931 luminance values as a function of reference turn angle. Notice that the luminance shifts are also approximately symmetrical in the positive and negative turn directions relative to the first reference turn angle of zero degrees. This symmetry about the first reference angle for both chromaticity and luminance shifts depends on the display device type. For instance, most OLED displays exhibit this symmetry, while most LCD devices do not. Symmetry, however, is not required for the present invention.

TABLE 1

| | | | | | 1931 CIE Y |
|---|---|---|---|---|---|
| Reference Turn | | | | | Tristimulus |
| Angle in degrees | | | | | (Luminance) Value |
| (Tip Angle = 0 deg.) | 1976 CIE u′ | 1976 CIE v′ | 1931 CIE x | 1931 CIE y | (cd/m²) |
| 80 | 0.2237 | 0.4869 | 0.3626 | 0.3507 | 66.38 |
| 75 | 0.2251 | 0.4846 | 0.362 | 0.3463 | 80.53 |
| 70 | 0.2232 | 0.4839 | 0.3588 | 0.3458 | 87.72 |
| 65 | 0.2183 | 0.482 | 0.351 | 0.3445 | 92.62 |
| 60 | 0.2156 | 0.4771 | 0.3428 | 0.3371 | 97.69 |
| 55 | 0.2189 | 0.4734 | 0.3433 | 0.3299 | 101.6 |
| 50 | 0.2224 | 0.4723 | 0.3465 | 0.327 | 103.9 |
| 45 | 0.2196 | 0.4689 | 0.3399 | 0.3225 | 106 |
| 40 | 0.214 | 0.4651 | 0.3297 | 0.3185 | 107.8 |
| 35 | 0.2089 | 0.4641 | 0.3227 | 0.3186 | 109.2 |
| 30 | 0.204 | 0.4649 | 0.3173 | 0.3215 | 111.4 |
| 25 | 0.2003 | 0.4675 | 0.3151 | 0.3267 | 114.4 |
| 20 | 0.1989 | 0.4696 | 0.3152 | 0.3307 | 116.7 |
| 15 | 0.1985 | 0.4701 | 0.3151 | 0.3316 | 118.3 |
| 10 | 0.1983 | 0.4701 | 0.3149 | 0.3318 | 119.3 |
| 5 | 0.1977 | 0.4701 | 0.3142 | 0.332 | 120.2 |
| 0 | 0.1975 | 0.4702 | 0.314 | 0.3321 | 120.2 |
| −5 | 0.1979 | 0.4702 | 0.3145 | 0.332 | 120.1 |
| −10 | 0.1982 | 0.4702 | 0.3148 | 0.3319 | 119.4 |
| −15 | 0.1987 | 0.4702 | 0.3154 | 0.3319 | 118.3 |
| −20 | 0.1992 | 0.4697 | 0.3156 | 0.3307 | 116.6 |
| −25 | 0.2004 | 0.4678 | 0.3154 | 0.3273 | 114.3 |
| −30 | 0.2038 | 0.4652 | 0.3174 | 0.322 | 111.3 |
| −35 | 0.2088 | 0.4643 | 0.3226 | 0.3189 | 108.8 |
| −40 | 0.2138 | 0.4654 | 0.3297 | 0.319 | 107.4 |
| −45 | 0.2196 | 0.4691 | 0.34 | 0.3229 | 105.4 |
| −50 | 0.2223 | 0.4726 | 0.3466 | 0.3274 | 103.1 |
| −55 | 0.2188 | 0.4735 | 0.3432 | 0.3302 | 101 |
| −60 | 0.2155 | 0.4771 | 0.3427 | 0.3372 | 97.17 |
| −65 | 0.218 | 0.482 | 0.3507 | 0.3446 | 92.48 |
| −70 | 0.223 | 0.4839 | 0.3586 | 0.3459 | 87.68 |
| −75 | 0.2249 | 0.4851 | 0.3622 | 0.3473 | 80.4 |
| −80 | 0.2238 | 0.4866 | 0.3624 | 0.3502 | 66.58 |

Referring to FIG. 1, the third step 12 in the calibration process according to the present invention is to select a target calibration angle based on the measured data. The target calibration angle can be selected based upon a number of criteria. One general criterion for selecting the target calibration angle is to choose a target calibration angle that reduces the perceived color angular dependence of the display within a range of viewing angles, relative to the same display calibrated at the first reference angle. Perceived color angular dependence can be reduced by studying color differences, for the color(s) of interest, between the first reference angle and several tip, turn, and/or combination tip/turn angles. Color differences can be calculated directly using the data from Table 1. While this is possible, chromaticity and luminance differences do not directly represent human visual color differences. Rather, the data in Table 1 should be transformed into a more uniform visual color difference space before calculating the color differences. An example of a more uniform visual color difference space is the CIE 1976 L*, a*, b* color difference space, more commonly known as the CIELAB color difference space. Other, more uniform visual color difference spaces could have been used, such as CIEDE2000. Table 2 shows the CIELAB data for the color of interest (white), at several reference turn angles, in both rectangular coordinates (L*, a*, b*) and polar coordinates (L*, C*_{ab}, hue angle). These data were calculated using the data in Table 1. Note that the CIE L* value at 0 degrees was normalized to 100, which corresponds to a maximum luminance of 120.2 cd/m2. The white reference for the CIELAB calculations was derived from the color of interest measured at zero degrees, which is a very close match to the CIE Standard Iluminant D65 aim.

The data in Table 2 provide insight into the nature of the perceived color shift with viewing angle. For example, FIG. 8 shows the b*, a* plot of the data in Table 2. Note that the b*, a* shifts are approximately symmetrical in the positive and negative turn directions relative to the first reference angle of zero degrees. The plots indicate both a hue and chroma shift. Generally, the hue of the white (color of interest) shifts towards the magenta direction initially, then towards the red direction with increasing positive or negative turn angle. The chroma of the white (color of interest) generally increases in proportion to the turn angle up to a C* of 18.89 and 18.73 at turn angles of +50 and −50 degrees, respectively. The chroma then decreases before peaking once again to a C*_{ab} of 19.89 and 19.88 at turn angles of +75 and −75 degrees, respectively, before decreasing.

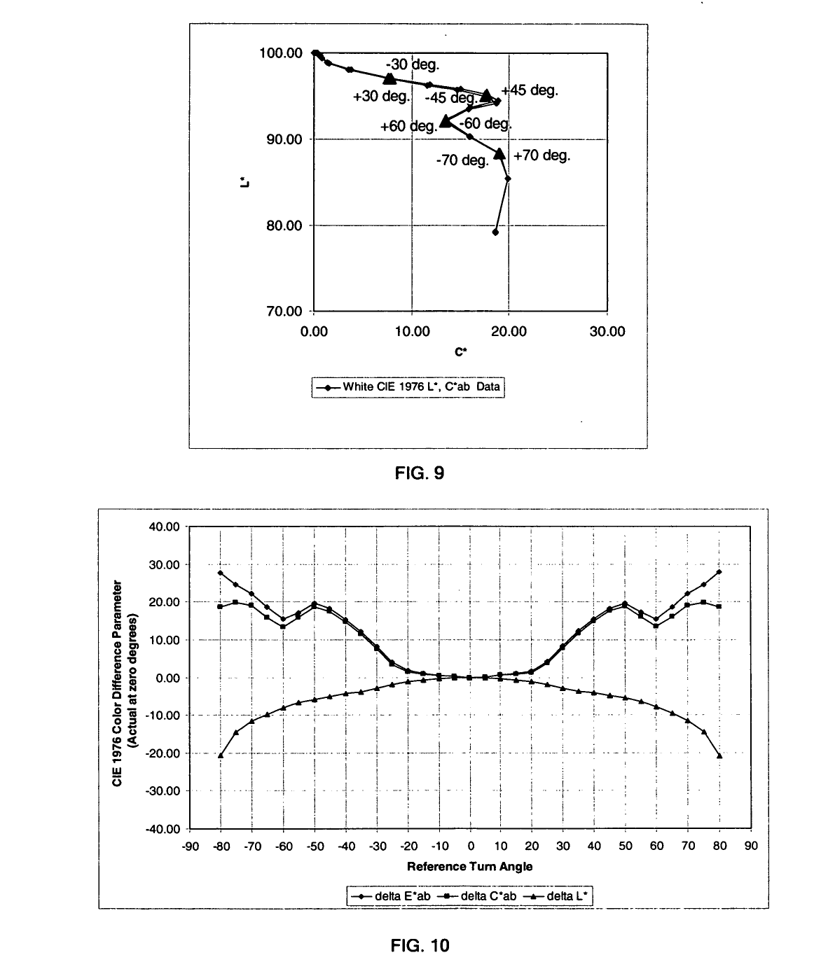

FIG. 9 shows the L*, C*_{ab} plot of the data in Table 2. Note that the L*, C* shifts are approximately symmetrical in the positive and negative turn directions relative to the first reference angle of zero degrees. The plot shows both a lightness and chroma shift. Generally, the white gets darker with increasing turn angle. The chroma behavior is similar to that shown in FIG. 8, but the chroma shifts are more clearly illustrated.

TABLE 2

| Reference Turn | | | | | |
|---|---|---|---|---|---|
| Angle in degrees | | | | | CIE 1976 hue |
| (Tip Angle = 0 deg.) | CIE 1976 L* | CIE 1976 a* | CIE 1976 b* | CIE 1976 C*_{ab} | angle |
| 80 | 79.17 | 12.41 | 13.88 | 18.62 | 48.19 |
| 75 | 85.50 | 14.89 | 13.19 | 19.89 | 41.55 |
| 70 | 88.44 | 14.17 | 12.79 | 19.09 | 42.09 |
| 65 | 90.35 | 11.56 | 11.08 | 16.01 | 43.78 |
| 60 | 92.25 | 11.46 | 7.04 | 13.45 | 31.55 |
| 55 | 93.68 | 15.35 | 4.55 | 16.01 | 16.50 |
| 50 | 94.50 | 18.44 | 4.09 | 18.89 | 12.51 |
| 45 | 95.24 | 17.67 | 1.14 | 17.71 | 3.68 |
| 40 | 95.87 | 14.78 | −2.32 | 14.97 | 351.08 |
| 35 | 96.35 | 11.24 | −3.58 | 11.80 | 342.32 |
| 30 | 97.10 | 7.02 | −3.47 | 7.83 | 0.00 |
| 25 | 98.10 | 3.27 | −1.88 | 3.77 | 330.17 |
| 20 | 98.86 | 1.33 | −0.32 | 1.37 | 346.60 |
| 15 | 99.39 | 0.83 | 0.01 | 0.83 | 0.87 |
| 10 | 99.71 | 0.63 | 0.05 | 0.63 | 4.81 |
| 5 | 100.00 | 0.16 | 0.00 | 0.16 | 359.55 |
| 0 | 100.00 | 0.00 | 0.00 | 0.00 | 0.00 |
| −5 | 99.97 | 0.32 | 0.06 | 0.32 | 9.94 |
| −10 | 99.74 | 0.52 | 0.07 | 0.53 | 7.91 |
| −15 | 99.39 | 0.84 | 0.19 | 0.86 | 12.46 |
| −20 | 98.83 | 1.54 | −0.24 | 1.56 | 351.07 |
| −25 | 98.07 | 3.13 | −1.59 | 3.51 | 333.07 |
| −30 | 97.06 | 6.81 | −3.25 | 7.55 | 334.48 |
| −35 | 96.21 | 11.02 | −3.48 | 11.56 | 342.48 |
| −40 | 95.73 | 14.51 | −2.12 | 14.66 | 351.68 |
| −45 | 95.03 | 17.48 | 1.31 | 17.53 | 4.27 |
| −50 | 94.22 | 18.24 | 4.25 | 18.73 | 13.12 |
| −55 | 93.46 | 15.12 | 4.63 | 15.82 | 17.03 |
| −60 | 92.06 | 11.35 | 7.04 | 13.36 | 31.83 |
| −65 | 90.29 | 11.38 | 11.05 | 15.86 | 44.17 |
| −70 | 88.42 | 14.03 | 12.79 | 18.99 | 42.35 |
| −75 | 85.45 | 14.53 | 13.56 | 19.88 | 43.04 |
| −80 | 79.27 | 12.55 | 13.70 | 18.57 | 47.51 |

The data in Table 2 can now be used to calculate the color differences in terms of the CIE 1976 CIELAB color difference equations. Table 3 shows the CIELAB color difference data for the color of interest (white), at the chosen reference turn angles. These differences were calculated using the equations of the CIE 1976 CIELAB color difference metric (see CIE Publication No.15:2004, Colorimetry 3rd Edition). By definition, delta H*_{ab} is zero because the color of interest (CIE Standard Illuminant D65) is achromatic. As stated previously, these color differences can then be used to select the target calibration angle 12. Also, other color difference metrics can be used in the target calibration angle selection process. These other metrics may have different weightings for the color difference components (e.g. lightness, chroma, and hue).

TABLE 3

| Reference Turn | | | | |
|---|---|---|---|---|
| Angle in degrees | CIE 1976 | CIE 1976 | CIE 1976 | CIE |
| (Tip Angle = 0 deg.) | delta L* | delta C*_{ab} | delta H*_{ab} | delta E*_{ab} |
| 80 | −20.83 | 18.62 | 0.00 | 27.94 |
| 75 | −14.50 | 19.89 | 0.00 | 24.61 |
| 70 | −11.56 | 19.09 | 0.00 | 22.32 |
| 65 | −9.65 | 16.01 | 0.00 | 18.70 |
| 60 | −7.75 | 13.45 | 0.00 | 15.52 |
| 55 | −6.32 | 16.01 | 0.00 | 17.21 |
| 50 | −5.50 | 18.89 | 0.00 | 19.67 |
| 45 | −4.76 | 17.71 | 0.00 | 18.34 |
| 40 | −4.13 | 14.97 | 0.00 | 15.53 |
| 35 | −3.65 | 11.80 | 0.00 | 12.35 |
| 30 | −2.90 | 7.83 | 0.00 | 8.35 |
| 25 | −1.90 | 3.77 | 0.00 | 4.22 |
| 20 | −1.14 | 1.37 | 0.00 | 1.78 |
| 15 | −0.61 | 0.83 | 0.00 | 1.03 |
| 10 | −0.29 | 0.63 | 0.00 | 0.69 |
| 5 | 0.00 | 0.16 | 0.00 | 0.16 |
| 0 | 0.00 | 0.00 | 0.00 | 0.00 |
| −5 | −0.03 | 0.32 | 0.00 | 0.32 |
| −10 | −0.26 | 0.53 | 0.00 | 0.59 |
| −15 | −0.61 | 0.86 | 0.00 | 1.06 |
| −20 | −1.17 | 1.56 | 0.00 | 1.95 |
| −25 | −1.93 | 3.51 | 0.00 | 4.00 |
| −30 | −2.94 | 7.55 | 0.00 | 8.10 |
| −35 | −3.79 | 11.56 | 0.00 | 12.16 |
| −40 | −4.27 | 14.66 | 0.00 | 15.27 |
| −45 | −4.97 | 17.53 | 0.00 | 18.22 |
| −50 | −5.78 | 18.73 | 0.00 | 19.60 |
| −55 | −6.54 | 15.82 | 0.00 | 17.12 |
| −60 | −7.94 | 13.36 | 0.00 | 15.54 |
| −65 | −9.71 | 15.86 | 0.00 | 18.60 |
| −70 | −11.58 | 18.99 | 0.00 | 22.24 |
| −75 | −14.55 | 19.88 | 0.00 | 24.63 |
| −80 | −20.73 | 18.57 | 0.00 | 27.84 |

FIG. 10 shows the total color difference (delta E*_{ab})as well as the lightness component (delta L*) and the chroma component (delta C*_{ab})of this CIELAB total color difference. Note that all the color difference data are symmetrical about the normal (reference turn angle =0). Similar results are to be expected if the angle data were shown. Once again, this symmetry may not be found for all flat panel displays, but the methods described herein can still be applied. Note that delta C*_{ab} is the main contributor to the total color difference out to a reference turn angle of approximately +/−75 degrees. After that, delta L* becomes somewhat more of a contributor to the total color difference than delta C*_{ab}.

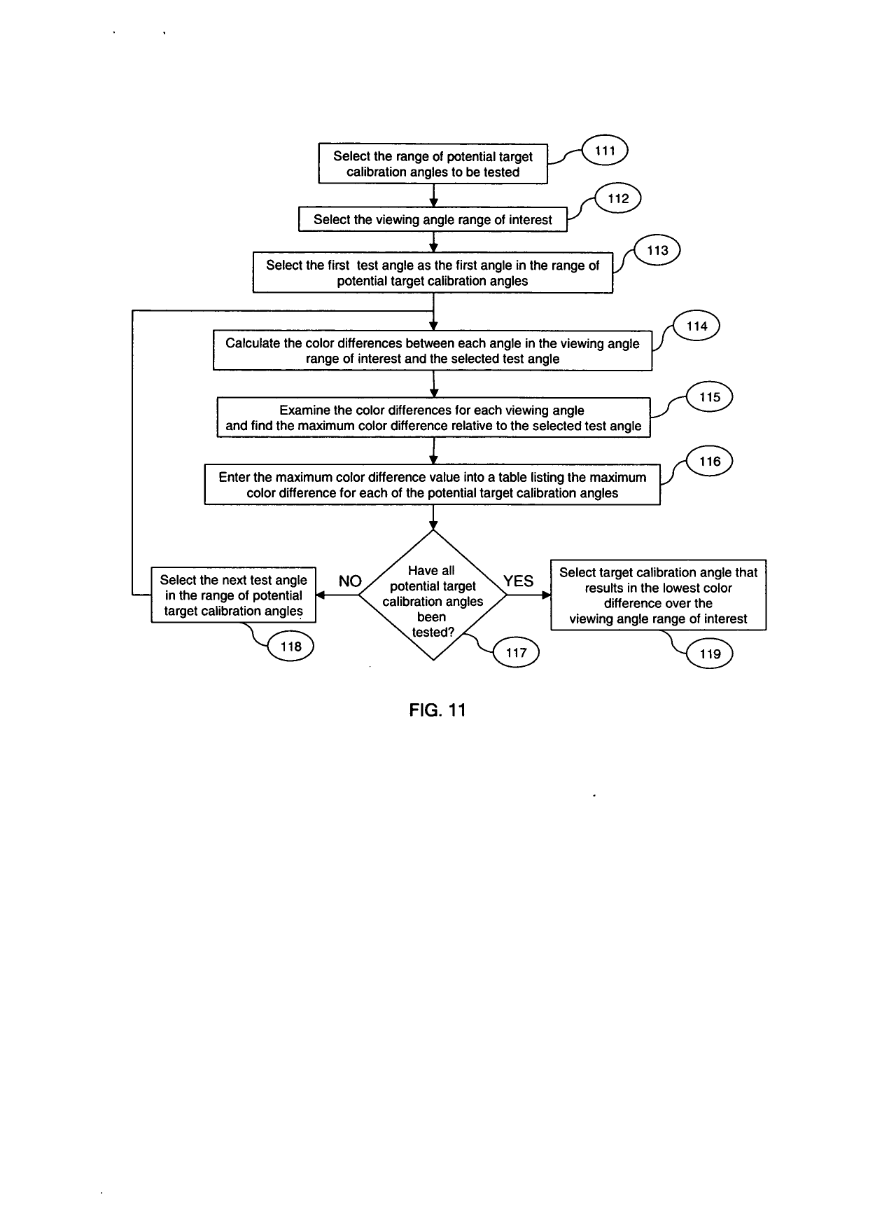

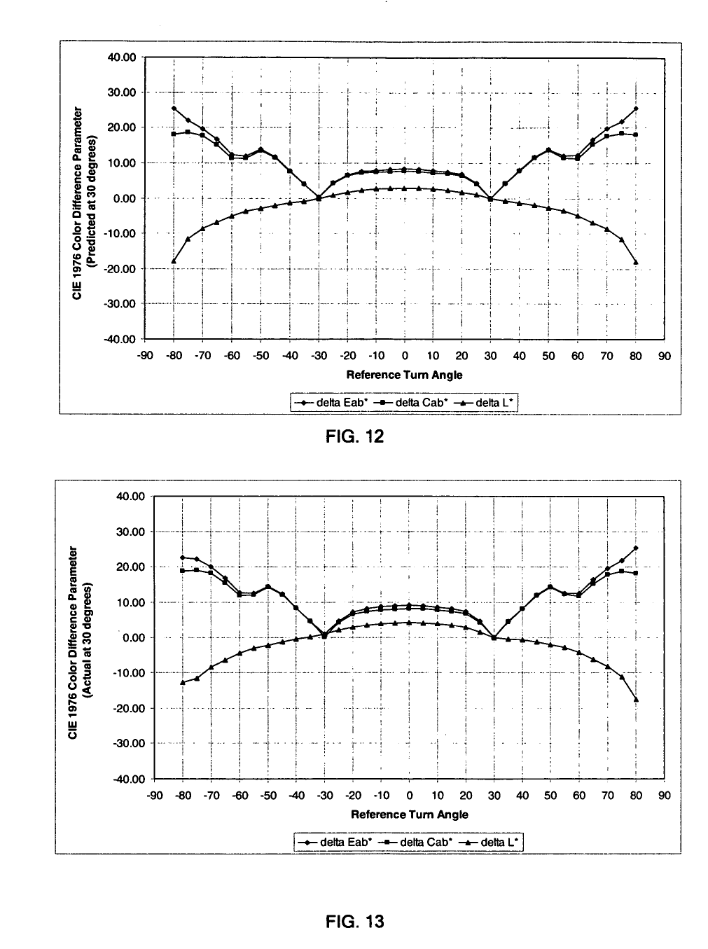

One method for selecting the target calibration angle is to maintain color differences for the at least one color of interest below a threshold value within a selected range of viewing angles. One version of this method is shown in detail in FIG. 11. A key assumption in the process of FIG. 11 is that the actual color differences between any two reference angles will remain equal, independent of the selected target calibration angle. The first step 111 in the process is to select the range of potential target calibration angles to be tested. In this example, the potential target calibration angles have been chosen to be between reference turn angles of +80 and −80 degrees in steps of 5 degrees. The second step 112 in the process is to select the viewing angle range of interest. In this example, the viewing angle range of interest has been chosen to be between +45 and −45 degrees in the turn direction. This viewing angle range is typical for a Digital Still Camera (DSC) application. The third step 113 in the process is to select the first test angle as the first angle in the range of potential target calibration angles. In this example, the first test angle is +80 degrees in the turn direction. The fourth step 114 in the process is to calculate the color differences between each angle in the viewing angle range of interest and the selected test angle. In this example, the CIELAB color differences (delta L*, delta C*_{ab}, delta H*_{ab},and delta E*_{ab})between +80 degrees and each angle in the viewing angle range of interest (+45 degrees to −45 degrees in steps of 5 degrees) are calculated. The results of this calculation are shown in Table 4a. As stated previously, other color difference metrics can be used in this calculation. The fifth step 115 in the process is to examine the color differences for each viewing angle in the range of interest and find the maximum color difference relative to the selected test angle. In this case, the maximum total color difference (CIELAB delta E*_{ab})is 27.94, as shown in bold text in Table 4a. In this case, the total color difference metric (CIELAB delta E*_{ab})was chosen to evaluate the color difference, but any of the individual components of the total CIELAB color difference metric (e.g. CIELAB delta C*_{ab}, delta L*, delta H*_{ab}) could have been used. The sixth step 116 in the process is to enter the maximum color difference value into a table listing the maximum color difference for each of the potential target calibration angles. Table 5a shows this partially completed table with data entered for only the first test angle of +80 degrees. The seventh step 117 in the process is to check to see if all the potential target angles have been tested. In this case, only the first potential target calibration angle (+80 degrees) has been tested, so the “NO” path is followed. The next step 118 along this path is to select the next test angle in the range of potential target calibration angles. In this case, the next test angle is +75 degrees. Process steps 114 through 118 are then repeated until Table 5a is completed. For example, the eleventh iteration through the process produces the color difference data for a test angle of +30 degrees shown in Table 4b. FIG. 12 is a plot of the predicted color difference data contained in Table 4b if the display had been actually calibrated at a turn angle of 30 degrees. Note that all the color difference data is expected to remain symmetrical about the normal (reference turn angle =0). Notice that the maximum color difference (CIELAB delta E*_{ab}) within the viewing angle range of interest is 11.75. The data for this test angle of +30 degrees is highlighted in Table 5b, which is a completed version of Table 5a. The last step 119 in the process, now that all potential target calibration angles have been tested, is to select the target calibration angle that results in the lowest color difference over the viewing angle range of interest. In this case, a target calibration of +30 degrees is selected since it is the potential target calibration angle with the lowest maximum color difference (11.75). In the end, the target calibration angle selected maintained the maximum color difference over the viewing angle range of interest below a total color difference threshold of 11.75. It is important to note, however, that this threshold cannot be chosen arbitrarily as it depends upon the color differences that can be achieved for a given display.

TABLE 4a

| | CIELAB Color differences between potential target | | | |
|---|---|---|---|---|
| Viewing Turn | calibration angle of +80 degrees and viewing turn angle. | | | |
| Angle in degrees | 1976 CIELAB | 1976 CIELAB | 1976 CIELAB | 1976 CIELAB |
| (Tip Angle = 0 deg.) | delta L* | delta C*_{ab} | delta H*_{ab} | delta E*_{ab} |
| 45 | 16.07 | 13.78 | 0.00 | 21.17 |
| 40 | 16.70 | 16.37 | 0.00 | 23.38 |
| 35 | 17.18 | 17.50 | 0.00 | 24.52 |
| 30 | 17.93 | 18.16 | 0.00 | 25.52 |
| 25 | 18.93 | 18.21 | 0.00 | 26.27 |
| 20 | 19.69 | 18.01 | 0.00 | 26.68 |
| 15 | 20.22 | 18.06 | 0.00 | 27.11 |
| 10 | 20.54 | 18.16 | 0.00 | 27.42 |
| 5 | 20.83 | 18.51 | 0.00 | 27.87 |
| 0 | 20.83 | 18.62 | 0.00 | 27.94 |
| −5 | 20.80 | 18.37 | 0.00 | 27.75 |
| −10 | 20.57 | 18.22 | 0.00 | 27.48 |
| −15 | 20.22 | 17.93 | 0.00 | 27.02 |
| −20 | 19.66 | 17.82 | 0.00 | 26.53 |
| −25 | 18.90 | 18.04 | 0.00 | 26.13 |
| −30 | 17.89 | 18.02 | 0.00 | 25.39 |
| −35 | 17.04 | 17.41 | 0.00 | 24.36 |
| −40 | 16.56 | 16.14 | 0.00 | 23.12 |
| −45 | 15.86 | 13.56 | 0.00 | 20.86 |

TABLE 4b

| | CIELAB Color differences between potential target | | | |
|---|---|---|---|---|
| Viewing Turn | calibration angle of +30 degrees and viewing turn angle. | | | |
| Angle in degrees | 1976 CIELAB | 1976 CIELAB | 1976 CIELAB | 1976 CIELAB |
| (Tip Angle = 0 deg.) | delta L* | delta C*_{ab} | delta H*_{ab} | delta E*_{ab} |
| 45 | −1.86 | 11.61 | 0.00 | 11.75 |
| 40 | −1.23 | 7.85 | 0.00 | 7.94 |
| 35 | −0.75 | 4.22 | 0.00 | 4.29 |
| 30 | 0.00 | 0.00 | 0.00 | 0.00 |
| 25 | 1.01 | 4.07 | 0.00 | 4.19 |
| 20 | 1.77 | 6.50 | 0.00 | 6.74 |
| 15 | 2.29 | 7.10 | 0.00 | 7.46 |
| 10 | 2.61 | 7.30 | 0.00 | 7.75 |
| 5 | 2.90 | 7.69 | 0.00 | 8.22 |
| 0 | 2.90 | 7.83 | 0.00 | 8.35 |
| −5 | 2.87 | 7.57 | 0.00 | 8.10 |
| −10 | 2.64 | 7.40 | 0.00 | 7.86 |
| −15 | 2.29 | 7.18 | 0.00 | 7.54 |
| −20 | 1.73 | 6.36 | 0.00 | 6.59 |
| −25 | 0.97 | 4.32 | 0.00 | 4.43 |
| −30 | −0.03 | 0.30 | 0.00 | 0.30 |
| −35 | −0.89 | 4.00 | 0.00 | 4.10 |
| −40 | −1.37 | 7.61 | 0.00 | 7.73 |
| −45 | −2.07 | 11.50 | 0.00 | 11.69 |

TABLE 5A
Maximum Color Difference within the Viewing Angle Range of Interest

| Potential Target | Max Delta E*_{ab} |
|---|---|
| Calibration Angle | (−45 to 45) |
| 80 | 27.94 |
| 75 | |
| 70 | |
| 65 | |
| 60 | |
| 55 | |
| 50 | |
| 45 | |
| 40 | |
| 35 | |
| 30 | |
| 25 | |
| 20 | |
| 15 | |
| 10 | |
| 5 | |
| 0 | |
| −5 | |
| −10 | |
| −15 | |
| −20 | |
| −25 | |
| −30 | |
| −35 | |
| −40 | |
| −45 | |
| −50 | |
| −55 | |
| −60 | |
| −65 | |
| −70 | |
| −75 | |
| −80 | |

TABLE 5b
Maximum Color Difference within
the Viewing Angle Range of Interest

| Potential Target | Max Delta E*_{ab} |
|---|---|
| Calibration Angle | (−45 to 45) |
| 80 | 27.94 |
| 75 | 24.61 |
| 70 | 22.32 |
| 65 | 18.70 |
| 60 | 15.52 |
| 55 | 17.21 |
| 50 | 19.67 |
| 45 | 18.34 |
| 40 | 15.53 |
| 35 | 12.35 |
| 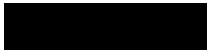 | 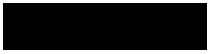 |
| 25 | 14.99 |
| 20 | 16.81 |
| 15 | 17.38 |
| 10 | 17.66 |
| 5 | 18.19 |
| 0 | 18.34 |
| −5 | 18.02 |
| −10 | 17.76 |
| −15 | 17.36 |
| −20 | 16.59 |
| −25 | 15.07 |
| −30 | 11.85 |
| −35 | 12.16 |
| −40 | 15.27 |
| −45 | 18.22 |
| −50 | 19.60 |
| −55 | 17.12 |
| −60 | 15.54 |
| −65 | 18.60 |
| −70 | 22.24 |
| −75 | 24.63 |
| −80 | 27.84 |

Referring to FIG. 1, the last step 13 in the calibration process according to the present invention is to recalibrate the display at the selected target calibration angle to obtain the desired chromaticity and/or luminance for the color(s) of interest. In this example, the target calibration angle was chosen to be +30 degress in the turn direction, so the display was recalibrated at this angle according to the process of FIG. 4 again choosing CIE Standard Illuminant D65 with a luminance of 120cd/m² as the color of interest. Table 6 shows the CIELAB color difference data for the color of interest (white), after this recalibration and transformation of the measured chromaticity and luminance data. FIG. 13 is a plot of the actual color difference data contained in Table 6, which is very similar to the prediction plot in FIG. 12. Notice that the color differences at +30 degrees are now zero. Also notice that the maximum CIELAB delta E*_{ab} value over the viewing angle range of interest is 12.31. This difference between the predicted maximum (11.75) and the actual maximum (12.31) may be due to slight variations in the calibration process or changes in the performance of the device with use over time.

TABLE 6

| Reference Turn | | | | |
|---|---|---|---|---|
| Angle in degrees | 1976 CIE | 1976 CIE | 1976 CIE | 1976 CIE |
| (Tip Angle = 0 deg.) | delta L* | delta C*_{ab} | delta H*_{ab} | delta E*_{ab} |
| 80 | −17.53 | 18.36 | 0.00 | 25.39 |
| 75 | −11.11 | 18.80 | 0.00 | 21.83 |
| 70 | −8.10 | 17.94 | 0.00 | 19.69 |
| 65 | −6.25 | 15.34 | 0.00 | 16.57 |
| 60 | −4.33 | 11.69 | 0.00 | 12.47 |
| 55 | −2.95 | 12.26 | 0.00 | 12.61 |
| 50 | −2.14 | 14.37 | 0.00 | 14.53 |
| 45 | −1.21 | 12.03 | 0.00 | 12.09 |
| 40 | −0.68 | 8.23 | 0.00 | 8.26 |
| 35 | −0.52 | 4.54 | 0.00 | 4.57 |
| 30 | 0.00 | 0.00 | 0.00 | 0.00 |
| 25 | 1.53 | 4.31 | 0.00 | 4.58 |
| 20 | 2.93 | 6.76 | 0.00 | 7.37 |
| 15 | 3.51 | 7.36 | 0.00 | 8.15 |
| 10 | 3.85 | 7.74 | 0.00 | 8.64 |
| 5 | 4.12 | 8.10 | 0.00 | 9.09 |
| 0 | 4.21 | 8.23 | 0.00 | 9.24 |
| −5 | 4.12 | 8.04 | 0.00 | 9.03 |
| −10 | 3.88 | 7.85 | 0.00 | 8.75 |
| −15 | 3.45 | 7.42 | 0.00 | 8.18 |
| −20 | 2.87 | 6.55 | 0.00 | 7.15 |
| −25 | 2.03 | 4.27 | 0.00 | 4.73 |
| −30 | 0.90 | 0.15 | 0.00 | 0.91 |
| −35 | 0.03 | 4.66 | 0.00 | 4.66 |
| −40 | −0.52 | 8.33 | 0.00 | 8.35 |
| −45 | −1.31 | 12.24 | 0.00 | 12.31 |
| −50 | −2.28 | 14.34 | 0.00 | 14.52 |
| −55 | −3.09 | 12.12 | 0.00 | 12.50 |
| −60 | −4.50 | 11.90 | 0.00 | 12.72 |
| −65 | −6.36 | 15.57 | 0.00 | 16.82 |
| −70 | −8.32 | 18.27 | 0.00 | 20.08 |
| −75 | −11.50 | 19.01 | 0.00 | 22.22 |
| −80 | −12.70 | 18.79 | 0.00 | 22.69 |

Another method for selecting the target calibration angle is to maintain color differences for the at least one color of interest below a threshold value within a selected range of viewing angles while keeping the color difference at a subset of viewing angles, within the viewing angle range of interest, below a lower threshold value For example, the subset of viewing angles could be selected as a single angle, 0 degrees. The process for selecting the target calibration angle using this method is similar to the process shown in FIG. 11, with differences in step 116 and 119. In step 116 of the alternative process, both the maximum color difference value and the color difference value at the subset of viewing angle are entered into a table similar to Table 5b. In this example, the color difference value at 0 degrees is entered as shown in Table 7.

TABLE 7
Maximum Color Difference and Color Difference at 0 degrees
within the Viewing Angle Range of Interest

| Potential Target | Max Delta E*_{ab} | Delta E*_{ab} at |
|---|---|---|
| Calibration Angle | (−45 to 45) | 0 degrees |
| 80 | 27.94 | 27.94 |
| 75 | 24.61 | 24.61 |
| 70 | 22.32 | 22.32 |
| 65 | 18.70 | 18.70 |
| 60 | 15.52 | 15.52 |
| 55 | 17.21 | 17.21 |
| 50 | 19.67 | 19.67 |
| 45 | 18.34 | 18.34 |
| 40 | 15.53 | 15.53 |
| 35 | 12.35 | 12.35 |
| 30 | 11.75 | 8.35 |
| 25 | 14.99 | 4.22 |
| 20 | 16.81 | 1.78 |
| 15 | 17.38 | 1.03 |
| 10 | 17.66 | 0.69 |
| 5 | 18.19 | 0.16 |
| 0 | 18.34 | 0.00 |
| −5 | 18.02 | 0.32 |
| −10 | 17.76 | 0.59 |
| −15 | 17.36 | 1.06 |
| −20 | 16.59 | 1.95 |
| −25 | 15.07 | 4.00 |
| −30 | 11.85 | 8.10 |
| −35 | 12.16 | 12.16 |
| −40 | 15.27 | 15.27 |
| −45 | 18.22 | 18.22 |
| −50 | 19.60 | 19.60 |
| −55 | 17.12 | 17.12 |
| −60 | 15.54 | 15.54 |
| −65 | 18.60 | 18.60 |
| −70 | 22.24 | 22.24 |
| −75 | 24.63 | 24.63 |
| −80 | 27.84 | 27.84 |

In step 119 of the alternative process, the target calibration angle is selected based upon the lowest maximum color difference over the viewing angle range of interest while also keeping the color differences at a subset of viewing angles, within the viewing angle range of interest, below a lower threshold value. In this example, a target calibration angle of 25 degrees may be chosen over a target calibration angle of 30 degrees in order to reduce the color difference at 0 degrees while still reducing the maximum color difference relative to the initial calibration data as shown in Table 3. In this case, the maximum color difference would be reduced from 18.34 in the original calibration, over the viewing angle range of interest, to 14.99. The color difference at 0 degrees would be below a threshold of 4.5 when calibrating at 25 degrees. If the display were calibrated at 30 degrees, the color difference at 0 degrees would have been 8.35. This is a performance trade-off that may be desired in certain applications.

Another method for selecting the target calibration angle is to reduce the aggregate value of the color differences for the at least one color of interest within a selected range of viewing angles. The process for selecting the target calibration angle using this method is similar to the process shown in FIG. 11, with differences in steps 115, 116 and 119. In step 115 of the process, the sum of the color differences is calculated over the viewing range of interest instead of finding the maximum color difference value over the viewing angle range of interest. In step 116 of the process, the aggregate color difference value (calculated in step 115) is entered into a table listing the color difference sum for each of the potential target calibration angles. In this example, the color difference sums for each of the potential target calibration angles are entered as shown in Table 8 for the viewing angle range of interest from +45 to −45 degrees in the turn direction. In step 119 of the process, the target calibration angle is selected based upon reducing the aggregate color difference value. In this example, a target calibration angle of −25 degrees may be chosen over a target calibration angle of 0 degrees in order to reduce the aggregate color difference. In this case, picking a target calibration angle of −25 degrees reduces the aggregate color difference value from 124.11 (at 0 degrees) to 108.73 over the viewing angle range of interest. Other target calibration angles could also have been chosen to reduce the aggregate color difference value relative to the aggregate color difference at a target calibration angle of 0 degrees (e.g. 15, 20, 25, −15, −20).

TABLE 8
Aggregate Color Difference within the Viewing Angle Range of Interest

| Potential Target | Angle Aggregate |
|---|---|
| Calibration | Delta E*_{ab} |
| (degrees) | (−45° to 45° ) |
| 80 | 486.52 |
| 75 | 413.28 |
| 70 | 373.40 |
| 65 | 316.04 |
| 60 | 246.03 |
| 55 | 242.59 |
| 50 | 274.10 |
| 45 | 237.44 |
| 40 | 189.75 |
| 35 | 153.79 |
| 30 | 125.02 |
| 25 | 109.61 |
| 20 | 109.80 |
| 15 | 112.77 |
| 10 | 115.21 |
| 5 | 121.83 |
| 0 | 124.11 |
| −5 | 119.81 |
| −10 | 116.33 |
| −15 | 113.44 |
| −20 | 109.11 |
| −25 | 108.73 |
| −30 | 123.14 |
| −35 | 151.75 |
| −40 | 186.14 |
| −45 | 236.05 |
| −50 | 273.85 |
| −55 | 242.33 |
| −60 | 246.94 |
| −65 | 315.10 |
| −70 | 372.54 |
| −75 | 416.09 |
| −80 | 483.80 |

Another method for selecting the target calibration angle is to reduce the average value of the color differences for the at least one color of interest within a selected range of viewing angles. The process for selecting the target calibration angle using this method is very similar to the process for selected the target calibration angle based on the aggregate color difference value (described above). The only difference in the process is that the average color difference value over the viewing angle range of interest is used instead of the aggregate color difference value in steps 115, 116, and 119. Other method for selecting the target calibration angle account for the probability of viewing the display at a particular tip, turn, or combination tip and turn angle for a particular application. Table 9 shows the probability of viewing a display at various turn angles from −80 to +80 degrees in an example application. This example assumes that the display is viewed at only one tip angle. For the purposes of this example, the tip angle is assumed to be 0 degrees. The most probable viewing angle is therefore at 0 degrees in both the tip and turn direction for this example.

TABLE 9

| Reference Turn | |
|---|---|
| Angle in degrees | Viewing Angle |
| (Tip Angle = 0 deg.) | Probability |
| 80 | 0.0% |
| 75 | 0.0% |
| 70 | 0.1% |
| 65 | 0.1% |
| 60 | 0.3% |
| 55 | 0.5% |
| 50 | 0.8% |
| 45 | 1.2% |
| 40 | 1.8% |
| 35 | 2.7% |
| 30 | 3.7% |
| 25 | 4.8% |
| 20 | 6.0% |
| 15 | 7.1% |
| 10 | 8.0% |
| 5 | 8.6% |
| 0 | 8.8% |
| −5 | 8.6% |
| −10 | 8.0% |
| −15 | 7.1% |
| −20 | 6.0% |
| −25 | 4.8% |
| −30 | 3.7% |
| −35 | 2.7% |
| −40 | 1.8% |
| −45 | 1.2% |
| −50 | 0.8% |
| −55 | 0.5% |
| −60 | 0.3% |
| −65 | 0.1% |
| −70 | 0.1% |
| −75 | 0.0% |
| −80 | 0.0% |

This probability data can be combined with methods that use color difference data to select the target calibration angle. For instance, the viewing angle probability data can be used to weight the color difference data in the method related to FIG. 11. More specifically, the viewing angle probability data would be used in step 114 when calculating the color differences between each angle and the viewing angle range of interest and the selected test angle. The calculation would be performed as before, except the results of this calculation would be multiplied by the probability at each angle to weight the results, resulting in a probability-weighted color difference value. This probability-weighted color difference value would then be used in steps 115, 116, and 119 to complete the target calibration angle selection methods as previously described. For example, the viewing angle probability data was used to modify the results previously reported in Table 4a. The results of this calculation are shown in Table 10 for the first test angle of +80 degrees.

TABLE 10

| | CIELAB Color differences between |
|---|---|
| | potential target calibration angle of |
| | +80 degrees and viewing turn |
| Viewing | angle. Weighted based on viewing |
| Turn Angle | angle probabilities. |
| in degrees | 1976 CIELAB Probability |
| Angle = 0 d | Weighted delta E*_{ab} |
| 45 | 0.26 |
| 40 | 0.43 |
| 35 | 0.65 |
| 30 | 0.93 |
| 25 | 1.26 |
| 20 | 1.35 |
| 15 | 1.92 |
| 10 | 2.19 |
| 5 | 2.40 |
| 0 | 2.46 |
| −5 | 2.39 |
| −10 | 2.20 |
| −15 | 1.91 |
| −20 | 1.58 |
| −25 | 1.25 |
| −30 | 0.93 |
| −35 | 0.65 |
| −40 | 0.43 |
| −45 | 0.25 |

The maximum probability-weighted color difference value within the viewing angle range of interest in this case is 2.46 at a viewing angle of 0 degrees in the turn direction. This maximum, probability-weighted color difference value is then entered into a table listing the maximum, probability-weighted color difference value for each of the potential target calibration angles. This process is repeated for each test angle in the range of potential target calibration angle. Table 11 shows the completed table of maximum, probability-weighted color difference value for each of the potential target calibration angles.

TABLE 11
Maximum Color Difference within the Viewing Angle Range of interest

| | Max Probability- |
|---|---|
| Potential Target | Weighted Delta E*_{ab} |
| Calibration Angle | (−45 to 45) |
| 80 | 2.46 |
| 75 | 2.17 |
| 70 | 1.97 |
| 65 | 1.65 |
| 60 | 1.37 |
| 55 | 1.52 |
| 50 | 1.73 |
| 45 | 1.62 |
| 40 | 1.37 |
| 35 | 1.09 |
| 30 | 0.74 |
| 25 | 0.37 |
| 20 | 0.29 |
| 15 | 0.30 |
| 10 | 0.31 |
| 5 | 0.33 |
| 0 | 0.33 |
| −5 | 0.32 |
| −10 | 0.32 |
| −15 | 0.31 |
| −25 | 0.35 |
| −30 | 0.71 |
| −35 | 1.07 |
| −40 | 1.35 |
| −45 | 1.61 |
| −50 | 1.73 |
| −55 | 1.51 |
| −60 | 1.37 |
| −65 | 1.64 |
| −70 | 1.96 |
| −75 | 2.17 |
| −80 | 2.45 |

The last step 119 in the process, now that all potential target calibration angles have been tested, is to select the target calibration angle that results in the lowest probability-weighted color difference over the viewing angle range of interest. In this case, a target calibration of −20 degrees is selected since it is the potential target calibration angle with the lowest maximum, probability-weighted color difference (0.28).

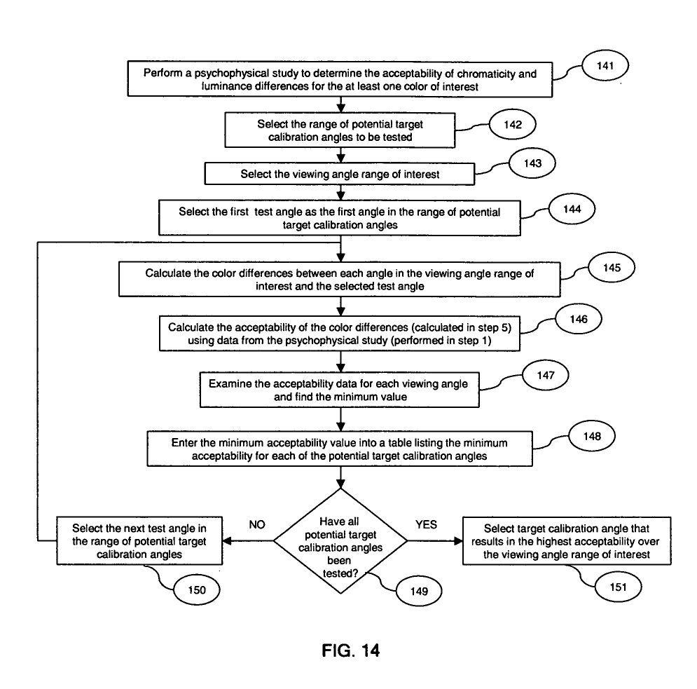

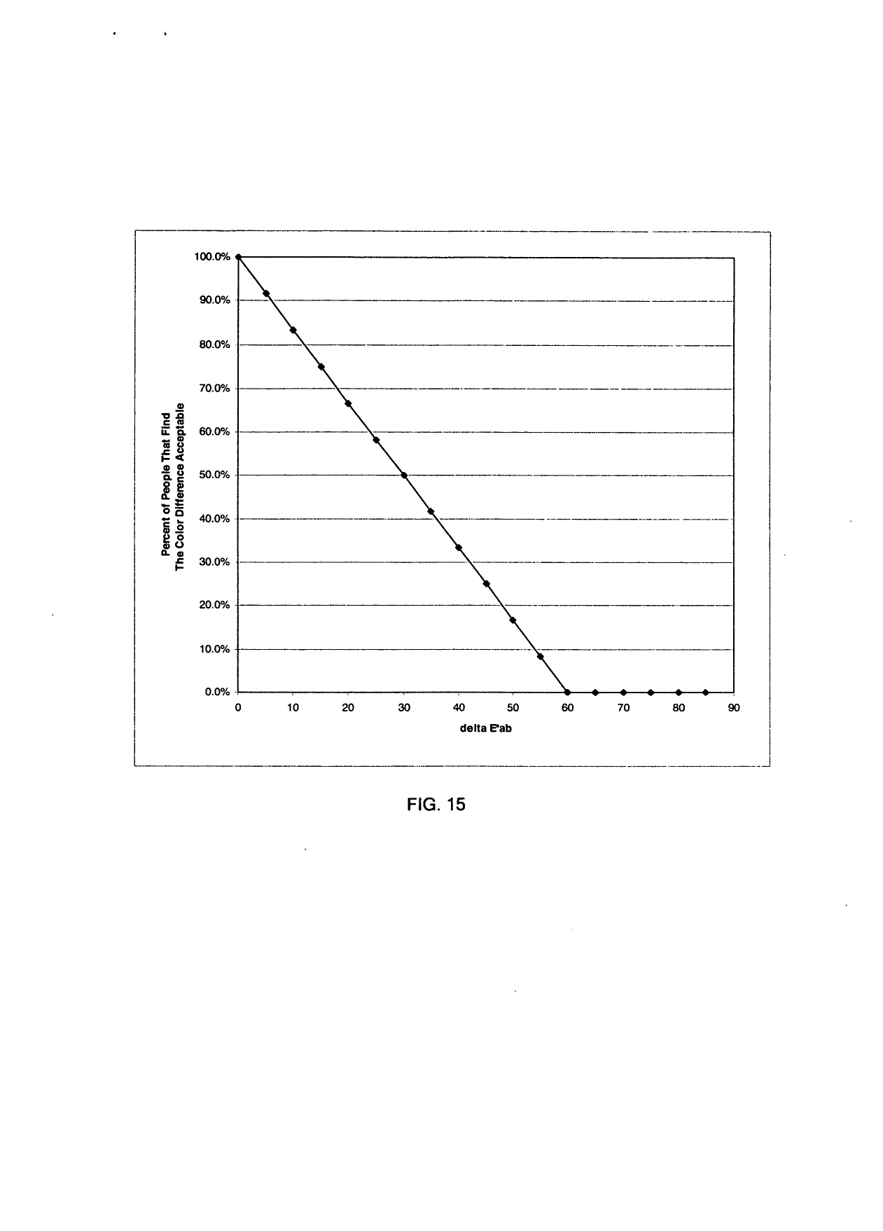

Another method for selecting the target calibration angle is to maintain an acceptability metric, based upon a psychophysical study of the acceptability of chromaticity and/or luminance differences for the at least one color of interest, below a threshold value within a selected range of viewing angles. The process for selecting the target calibration angle using this method is shown in FIG. 14. The first step 141 in the process is to perform a psychophysical study to determine the acceptability of chromaticity and luminance differences for the at least one color of interest. One method for collecting this data is to show observers images with and without chromaticity and luminance differences and gather subjective acceptability scores for difference magnitudes. In this example, the chromaticity and luminance difference data was used to calculate the corresponding CIELAB total color difference data (delta E*_{ab}). FIG. 15 shows the acceptability of various delta E*_{ab} values based on a representative psychophysical study. Notice that 100% of the people find the color difference acceptable when the delta E*_{ab} is zero. Also notice that 0% of the people find the color difference acceptable when the delta E*_{ab} is greater than or equal to 60. The second step 142 in the process is to select the range of potential target calibration angles to be tested. In this example, the potential target calibration angles have been chosen to be between reference turn angles of +80 and −80 degrees in steps of 5 degrees. The third step 143 in the process is to select the viewing angle range of interest. In this example, the viewing angle range of interest has been chosen to be between +45 and −45 degrees in the turn direction. This viewing angle range is typical for a Digital Still Camera (DSC) application. The fourth step 144 in the process is to select the first test angle as the first angle in the range of potential target calibration angles. In this example, the first test angle is +80 degrees in the turn direction. The fifth step 145 in the process is to calculate color differences between each angle in the viewing angle range of interest and the elected test angle. In this example, the CIELAB color differences (delta L*, delta C*_{ab}, delta H*_{ab},and delta E*_{ab})between +80 degrees and each angle in the viewing angle range of interest (+45 degrees to −45 degrees in steps of 5 degrees) are calculated. The results of this calculation are shown in Table 12. As stated previously, other color difference metrics can be used in this calculation. The sixth step 146 in the process is to calculate the acceptability of the color differences (calculated in step 145) using data from the psychophysical study (performed in step 141). The results of this acceptability are also shown in Table 12.

TABLE 12

| | | Acceptability of Color |
|---|---|---|
| | | differences between potential |
| | | target calibration angle of |
| Viewing | | +80 degrees and viewing |
| Turn Angle | | turn angle. |
| in degrees | 1976 CIELAB | Acceptability of |
| (Tip Angle = 0 deg.) | Delta E*_{ab} | Color Difference |
| 45 | 21.17 | 64.7% |
| 40 | 23.38 | 61.0% |
| 35 | 24.52 | 59.1% |
| 30 | 25.52 | 57.5% |
| 25 | 26.27 | 56.2% |
| 20 | 26.68 | 55.5% |
| 15 | 27.11 | 54.8% |
| 10 | 27.42 | 54.3% |
| 5 | 27.87 | 53.6% |
| 0 | 27.94 | 53.4% |
| −5 | 27.75 | 53.8% |
| −10 | 27.48 | 54.2% |
| −15 | 27.02 | 55.0% |
| −20 | 26.53 | 55.8% |
| −25 | 26.13 | 56.5% |
| −30 | 25.39 | 57.7% |
| −35 | 24.36 | 59.4% |
| −40 | 23.12 | 61.5% |
| −45 | 20.86 | 65.2% |

The seventh step 147 is to examine the acceptability data for each the range of interest and find the minimum acceptability value. In this case, the minimum acceptablity value is 53.4%, as shown in bold text in Table 12. The eight step 148 in the process is to enter the minimum acceptability value into a table listing the minimum acceptability value for each of the potential target calibration angles. Table 13 shows the completed table. Notice that the value 53.4% is entered in the table for the potential target calibration angle of +80 degrees.

TABLE 13
Minimum Acceptabilty within the Viewing Angle Range of Interest

| | Min |
|---|---|
| Potential Target | Acceptability |
| Calibration Angle | (−45 to 45) |
| 80 | 53.4% |
| 75 | 59.0% |
| 70 | 62.8% |
| 65 | 68.8% |
| 60 | 74.1% |
| 55 | 71.3% |
| 50 | 67.2% |
| 45 | 69.4% |
| 40 | 74.1% |
| 35 | 79.4% |
| 30 | 80.4% |
| 25 | 75.0% |
| 20 | 72.0% |
| 15 | 71.0% |
| 10 | 70.6% |
| 5 | 69.7% |
| 0 | 69.4% |
| −5 | 70.0% |
| −10 | 70.4% |
| −15 | 71.1% |
| −20 | 72.4% |
| −25 | 74.9% |
| −30 | 80.2% |
| −35 | 79.7% |
| −40 | 74.5% |
| −45 | 69.6% |
| −50 | 67.3% |
| −55 | 71.5% |
| −60 | 74.1% |
| −65 | 69.0% |
| −70 | 62.9% |
| −75 | 58.9% |
| −80 | 53.6% |

The ninth step 149 in the process is to check to see if all the potential target angles have been tested. The “NO” path is followed, and the next test angle in the range of potential target calibration angles is selected 150, until all the potential target calibration angles have been tested. These iterations through the process, steps 145 through step 150, complete Table 13. The last step 151 in the process, now that all potential target calibration angles have been tested, is to select the target calibration angle that results in the highest acceptability over the viewing angle range of interest. In this case, a target calibration of +30 degrees is selected since it is the potential target calibration angle with the highest acceptability (80.4%). In the end, the target calibration angle selected maintained the minimum acceptability over the viewing angle range of interest above an acceptability threshold of 80%. It is important to note, however, that this threshold cannot be chosen arbitrarily as it depends upon the acceptability data that can be achieved for a given display according to the psychophysical study that was performed in step 141.

Another method for selecting the target calibration angle is to maintain acceptability for the at least one color of interest above a threshold value within a selected range of viewing angles while keeping the acceptability for a subset of viewing angles, within the viewing angle range of interest, above a greater threshold value. This is similar to the variation of the process in FIG. 11 that uses Table 7 to select the target calibration angle.

Another method for selecting the target calibration angle is to maximize the aggregate value of the acceptability data for the at least one color of interest within the selected range of viewing angles. This is similar to the variation of the process in FIG. 11 that uses Table 8 to select the target calibration angle.

Another method for selecting the target calibration angle is to increase the average value of the acceptability data for the at least one color of interest within the selected range of viewing angles. This is similar to the variation of the process in FIG. 11 that uses Table 8 to select the target calibration angle. The only difference is that the average acceptability data is used instead of the aggregate acceptability data.

Another method for selecting the target calibration angle is to use the acceptability data for the at least one color of interest within the selected range of viewing angles, as described above, while further accounting for the probability of viewing the display at a particular tip, turn, or combination tip and turn angle for a particular application. This is similar to the variation of the process in FIG. 11 that uses Tables 9 through 11 to select the target calibration angle based upon probability weighted color difference values. The only difference is that the acceptability data is used instead of the color difference data.

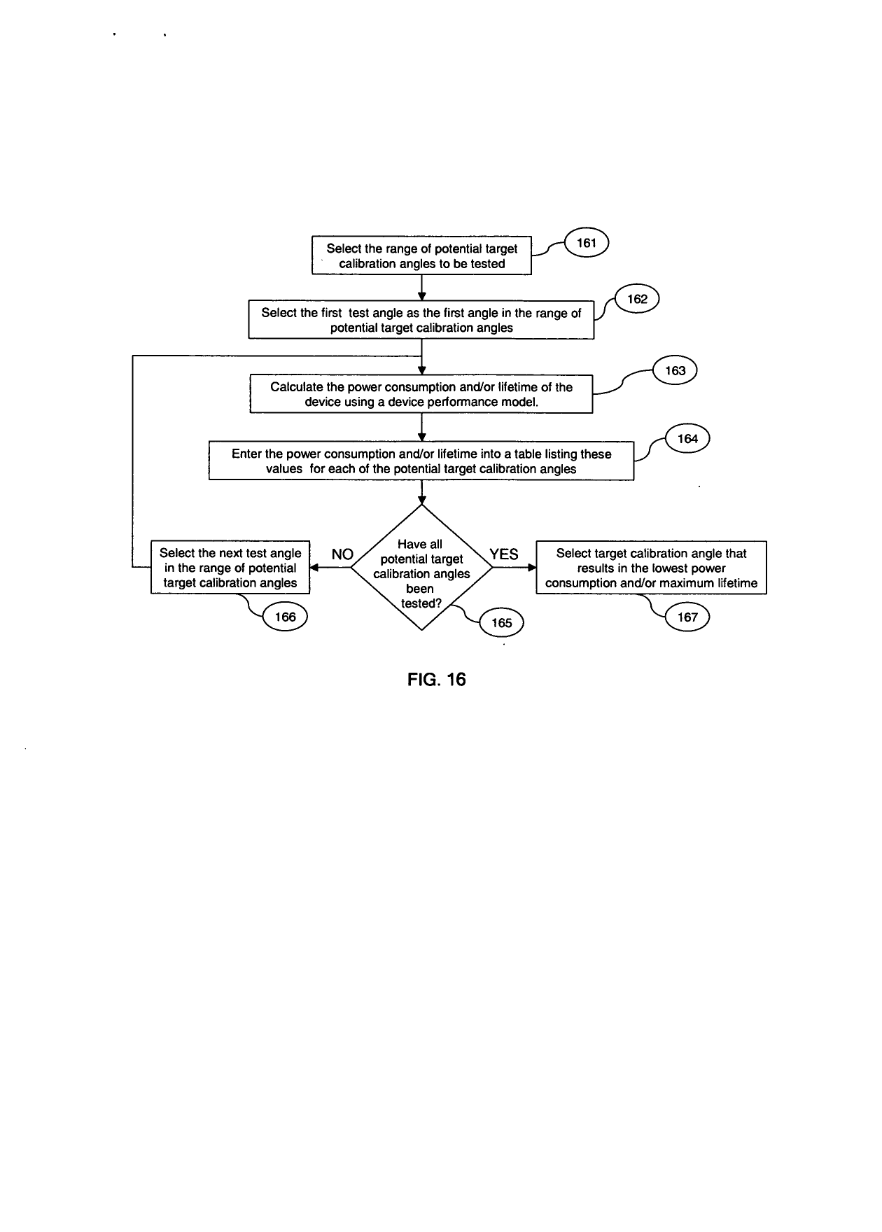

Another method for selecting the target calibration angle is to reduce the power consumption and/or increase the lifetime of the display while establishing desired chromaticity and/or luminance for the colors of interest. The process for selecting the target calibration angle using this method is shown in FIG. 16. The first step 161 in the process is to select the range of potential target calibration angles to be tested. In this example, the potential target calibration angles have been chosen to be between reference turn angles of +80 and −80 degrees in steps of 5 degrees. The second step 162 in the process is to select the first test angle as the first angle in the range of potential target calibration angles. In this example, the first test angle is +80 degrees in the turn direction. The third step 163 in the process is to calculate the power consumption and/or lifetime using an appropriate flat panel display performance model, e.g. display performance models may be developed based on actual measured performance of similar test models. The fourth step 164 in the process is to enter the power consumption and/or lifetime into a table listing these values for each of the potential target calibration angles. An exemplary completed table is shown in Table 14. The fifth step 165 in the process is to check to see if all the potential target angles have been tested. The “NO” path is followed, and the next test angle in the range of potential target calibration angles is selected 166, until all the potential target calibration angles have been tested. These iterations through the process, steps 163 through step 166, complete Table 14. The last step 167 in the process, now that all potential target calibration angles have been tested, is to select the target calibration angle that results in the lowest power consumption and/or the maximum lifetime. In this case, if power consumption is the criterion for selecting the target calibration angle, an angle of +15 degrees would be selected since it is the potential target calibration angle with the lowest power consumption (759.7 mW). Alternately, if lifetime is the criterion for selecting the target calibration angle, an angle of +25 degrees would be selected since it is the potential target calibration angle with the longest lifetime (1733.0 hours). If both power consumption and lifetime are chosen as the criteria for selecting the target 10 calibration angle, then one method of making the selection is to use a figure of merit that is a ratio of lifetime divided by power consumption. This method results in a higher figure of merit value for devices with lower power consumption and longer lifetime. The results of the figure of merit calculation are shown in Table 15. In this case, an angle of +20 degrees would be selected as the target calibration angle since it is the potential target calibration angle with the highest figure of merit value (2.18). Other figure of merit calculation methods could have been used, and each may produce different results.

TABLE 14

| Potential | | |
|---|---|---|
| Target | | |
| Calibration | Power | |
| Angle | Consumption | Lifetime |
| (degrees) | (mW) | (hours) |
| 80 | 1397.1 | 924.1 |
| 75 | 1187.9 | 1219.2 |
| 70 | 1112.7 | 1309.3 |
| 65 | 1084.3 | 1355.1 |
| 60 | 1042.6 | 1419.3 |
| 55 | 983.6 | 1450.0 |
| 50 | 942.0 | 1447.1 |
| 45 | 932.7 | 1421.2 |
| 40 | 936.9 | 1339.7 |
| 35 | 932.9 | 1402.1 |
| 30 | 906.4 | 1594.8 |
| 25 | 850.2 | 1733.0 |
| 20 | 790.4 | 1723.7 |
| 15 | 759.7 | 1646.4 |
| 10 | 776.8 | 1538.3 |
| 5 | 824.9 | 1443.8 |
| 0 | 860.0 | 1416.6 |
| −5 | 824.8 | 1437.0 |
| −10 | 776.6 | 1523.0 |
| −15 | 760.1 | 1628.5 |
| −20 | 789.9 | 1709.7 |
| −25 | 851.5 | 1715.2 |
| −30 | 908.2 | 1574.2 |
| −35 | 937.7 | 1387.8 |
| −40 | 941.9 | 1353.0 |
| −45 | 938.8 | 1417.9 |
| −50 | 950.0 | 1451.5 |
| −55 | 990.2 | 1451.9 |
| −60 | 1048.7 | 1420.6 |
| −65 | 1087.4 | 1330.6 |
| −70 | 1113.7 | 1305.2 |
| −75 | 1191.7 | 1209.6 |
| −80 | 1393.7 | 928.5 |

TABLE 15

| Potential Target | | | |
|---|---|---|---|
| Calibration Angle | Power Consumption | Lifetime | Power and Lifetime |
| (degrees) | (mW) | (hours) | Figure of Merit |
| 80 | 1397.1 | 924.1 | 0.66 |
| 75 | 1187.9 | 1219.2 | 1.03 |
| 70 | 1112.7 | 1309.3 | 1.18 |
| 65 | 1084.3 | 1355.1 | 1.25 |
| 60 | 1042.6 | 1419.3 | 1.36 |
| 55 | 983.6 | 1450.0 | 1.47 |
| 50 | 942.0 | 1447.1 | 1.54 |
| 45 | 932.7 | 1421.2 | 1.52 |
| 40 | 936.9 | 1339.7 | 1.43 |
| 35 | 932.9 | 1402.1 | 1.50 |
| 30 | 906.4 | 1594.8 | 1.76 |
| 25 | 850.2 | 1733.0 | 2.04 |
| 20 | 790.4 | 1723.7 | 2.18 |
| 15 | 759.7 | 1646.4 | 2.17 |
| 10 | 776.8 | 1538.3 | 1.98 |
| 5 | 824.9 | 1443.8 | 1.75 |
| 0 | 860.0 | 1416.6 | 1.65 |
| −5 | 824.8 | 1437.0 | 1.74 |
| −10 | 776.6 | 1523.0 | 1.96 |
| −15 | 760.1 | 1628.5 | 2.14 |
| −20 | 789.9 | 1709.7 | 2.16 |
| −25 | 851.5 | 1715.2 | 2.01 |
| −30 | 908.2 | 1574.2 | 1.73 |
| −35 | 937.7 | 1387.8 | 1.48 |
| −40 | 941.9 | 1353.0 | 1.44 |
| −45 | 938.8 | 1417.9 | 1.51 |
| −50 | 950.0 | 1451.5 | 1.53 |
| −55 | 990.2 | 1451.9 | 1.47 |
| −60 | 1048.7 | 1420.6 | 1.35 |
| −65 | 1087.4 | 1330.6 | 1.22 |
| −70 | 1113.7 | 1305.2 | 1.17 |
| −75 | 1191.7 | 1209.6 | 1.01 |
| −80 | 1393.7 | 928.5 | 0.67 |

Another method for selecting the target calibration angle is to include criteria that improve the overall performance of the display based on power consumption, lifetime, and desired chromaticity and/or luminance for the colors of interest. This method is similar to the power and lifetime method described above, but it combines the power and lifetime method with previously described methods related to selecting a target calibration angle based on color difference metrics or an acceptability metric. For example, the target calibration angle can be selected using a figure of merit based on power, lifetime, and the color difference metric from Table 5b. One method of making the selection is to use a figure of merit that is a ratio of lifetime divided by power consumption divided by the maximum color difference for the viewing angle range of interest. This method results in a higher figure of merit value for devices with lower power consumption, longer lifetime, and a lower maximum color difference within the viewing angle range of interest. The results of the figure of merit calculation are shown in Table 16. In this case, an angle of +30 degrees would be selected as the target calibration angle since it is the potential target calibration angle with the highest figure of merit value (0.150). Other figure of merit calculation methods could have been used, e.g. employing any desired weighting parameters, and each may produce different results.

TABLE 16

| Potential | | | | |
|---|---|---|---|---|
| Target | | | | Power, Lifetime, |
| Calibration | Power | | Max Delta | and Color |
| Angle | Consumption | Lifetime | E*_{ab} | Difference Figure |
| (degrees) | (mW) | (hours) | (−45 to 45) | of Merit |
| 80 | 1397.1 | 924.1 | 27.9 | 0.024 |
| 75 | 1187.9 | 1219.2 | 24.6 | 0.042 |
| 70 | 1112.7 | 1309.3 | 22.3 | 0.053 |
| 65 | 1084.3 | 1355.1 | 18.7 | 0.067 |
| 60 | 1042.6 | 1419.3 | 15.5 | 0.088 |
| 55 | 983.6 | 1450.0 | 17.2 | 0.086 |
| 50 | 942.0 | 1447.1 | 19.7 | 0.078 |
| 45 | 932.7 | 1421.2 | 18.3 | 0.083 |
| 40 | 936.9 | 1339.7 | 15.5 | 0.092 |
| 35 | 932.9 | 1402.1 | 12.3 | 0.122 |
| 30 | 906.4 | 1594.8 | 11.8 | 0.150 |
| 25 | 850.2 | 1733.0 | 15.0 | 0.136 |
| 20 | 790.4 | 1723.7 | 16.8 | 0.130 |
| 15 | 759.7 | 1646.4 | 17.4 | 0.125 |
| 10 | 776.8 | 1538.3 | 17.7 | 0.112 |
| 5 | 824.9 | 1443.8 | 18.2 | 0.096 |
| 0 | 860.0 | 1416.6 | 18.3 | 0.090 |
| −5 | 824.8 | 1437.0 | 18.0 | 0.097 |
| −10 | 776.6 | 1523.0 | 17.8 | 0.110 |
| −15 | 760.1 | 1628.5 | 17.4 | 0.123 |
| −20 | 789.9 | 1709.7 | 16.6 | 0.130 |
| −25 | 851.5 | 1715.2 | 15.1 | 0.134 |
| −30 | 908.2 | 1574.2 | 11.9 | 0.146 |
| −35 | 937.7 | 1387.8 | 12.2 | 0.122 |
| −40 | 941.9 | 1353.0 | 15.3 | 0.094 |
| −45 | 938.8 | 1417.9 | 18.2 | 0.083 |
| −50 | 950.0 | 1451.5 | 19.6 | 0.078 |
| −55 | 990.2 | 1451.9 | 17.1 | 0.086 |
| −60 | 1048.7 | 1420.6 | 15.5 | 0.087 |
| −65 | 1087.4 | 1330.6 | 18.6 | 0.066 |
| −70 | 1113.7 | 1305.2 | 22.2 | 0.053 |
| −75 | 1191.7 | 1209.6 | 24.6 | 0.041 |
| −80 | 1393.7 | 928.5 | 27.8 | 0.024 |

### PARTS LIST

10 calibrate display step
11 measure chromaticity and/or luminance step
12 select target calibration angle step
13 recalibrate display step
20 flat panel display
21 chromaticity and/or luminance measuring device
22 computer
23 stage
28 tip directional axis
29 turn directional axis
30 display target #1 low level code value step
32 measure target #1 value step
34 compare step
36 adjust gain/offset step
38 display target #2 intermediate code value step
40 measure target #2 value step
42 compare step
44 adjust gain/offset step
46 display target #3 high level code value step
48 measure target #3 value step
50 compare step
52 adjust gain/offset step
111 select target calibration angle range step
112 select viewing angle range step
113 select test angle step
114 calculate color differences step
115 find maximum color difference relative to test angle step
116 enter maximum color difference into table step
117 determine if all potential calibration angles have been tested step
118 select next test angle step
119 select the target calibration angle step
141 determine acceptability from psychophysical study step
142 select target calibration angle range step
143 select viewing angle range step
144 select test angle step
145 calculate color difference step
146 calculate acceptability of color difference step
147 find minimum acceptability for each viewing angle step
148 enter minimum acceptability into table step
149 determine if all potential calibration angles have been tested step
150 select next test angle step
151 select the target calibration angle step
161 select target calibration angle range step
162 select test angle step
163 calculate power consumption and/or lifetime step
164 enter power and/or lifetime into table step
165 determine if all potential calibration angles have been tested step
166 select next test angle step
167 select target calibration angle step

What is claimed is:

1. A method of calibrating a flat panel, comprising the steps of:
a) providing a flat panel display,
b) calibrating the display to establish desired chromaticity and/or luminance for one or more colors of interest at a first reference angle,c) measuring the chromaticity and/or luminance data for at least one color of interest at a minimum of one additional reference angle distinct from the first reference angle, and
d) selecting a target calibration angle in response to the measured data and calibrating the display to establish desired chromaticity and/or luminance for colors of interest at the selected target calibration angle.

2. A method as claimed in claim 1, wherein the selected target calibration angle in step d) is selected to provide reduced perceived color angular dependence of the display within a range of viewing angles relative to the same display calibrated at the first reference angle.

3. A method as claimed in claim 1 wherein the flat panel display provided in step a) is an OLED display.

4. A method as claimed in claim 1 wherein the first reference angle in step b) is at an angle of zero degrees relative to normal.

5. A method as claimed in claim 1 wherein the first reference angle in step b) is at a tip angle, turn angle or a combination tip and turn angle relative to normal.

6. A method as claimed in claim 1 wherein the one or more colors of interest in step b) include the white point of the display.

7. A method as claimed in claim 1 wherein the one or more colors of interest in step b) comprises a group of colors.

8. A method as claimed in claim 1 wherein the at least one color of interest in step c) is different from the one or more colors of interest in step b).

9. A method as claimed in claim 1 wherein the at least one color of interest in step c) is the white point of the display.

10. A method as claimed in claim 1 wherein the at least one color of interest in step c) is a single color.

11. A method as claimed in claim 1 wherein the at least one color of interest in step c) comprises a group of colors.

12. A method as claimed in claim 1 wherein the chromaticity and/or luminance data for at least one color of interest is measured in step c) at a plurality of additional reference angles distinct from the first reference angle, and the plurality of additional reference angles are selected from tip angles, turn angles and/or combinations of tip and turn angles relative to the first reference angle.

13. A method as claimed in claim 12 wherein the additional reference angles in step c) comprise a sampling of the full range of physically possible tip angles, turn angles and combination tip and turn angles.

14. A method as claimed in claim 12 wherein the additional reference angles in step c) comprise a range of tip angles, turn angles and combination tip and turn angles that lie within a range of anticipated viewing angles for use in a particular application.

15. A method as claimed in claim 1 wherein the criteria for selecting the target calibration angle in step d) is based on maintaining color differences for the at least one color of interest below a threshold value and/or reducing the aggregate or average value of such differences within a selected range of viewing angles.

16. A method as claimed in claim 15 wherein the criteria for selecting the target angle in step d) further accounts for keeping the color difference at a subset of viewing angles, within the viewing angle range of interest, below a lower threshold value.

17. A method as claimed in claim 1 wherein the criteria for selecting the target calibration angle in step d) is based on maintaining an acceptability metric above a threshold value and/or maximizing the aggregate value of the acceptability metric within a selected range of viewing angles, wherein the acceptability metric is based on psychophysical study of the acceptability of chromaticity and/or luminance differences for the at least one color of interest over the selected range of viewing angles.

18. A method as claimed in claim 1 wherein the criteria for selecting the target angle in step d) includes reducing the power consumption and/or increasing lifetime of the display.

19. A method as claimed in claim 1 wherein the criteria for selecting the target calibration angle in step d) accounts for the probability of viewing the display at a particular tip, turn or combination tip and turn angle for a particular application.

20. A display calibrated according to the method of claim 1.
